(19) United States
(12) Patent Application Publication
(10) Pub. No.: US 2004/0151842 A1
(43) Pub. Date: Aug. 5, 2004

(54) Method and device for coating a plastic container

(76) Inventor: Heinz Humele, Thalmassing (DE)

Correspondence Address: Flynn Thiel, Boutell & Tanis, 2026 Rambling Road, Kalamazoo, MI, 49008-1631, US

(21) Appl. No.: 10/473,219

(22) PCT Filed: Mar. 27, 2002
(86) PCT No.: PCT/EP02/03462

(30) Foreign Application Priority Data
Mar. 27, 2001 (DE) 101 15 087.3

(51) Int. Cl. B05D 1/02; B05D 1/04

(52) U.S. Cl. 427/458; 118/626

(57) ABSTRACT

Described is a method and an apparatus for coating a plastic container, especially a PET bottle, and a conveying means therefor that permit, in a constructionally simple manner, an inexpensive and effective improvement of the barrier properties thereof. To this end, the container is provided on its outside with a liquid coating agent by at least one rotating atomizer, and the coating is subsequently dried.

The present invention relates to a method and an apparatus for coating a plastic container, particularly a PET bottle, of the type described in the preambles of claims 1 and 6, respectively. The invention further relates to a conveying means for conveying a plastic container, particularly a PET bottle, of the type explained in the preamble of claim 17.

A method, an apparatus and a conveying means of said type are known from WO 95/29 860. The known apparatus is designed for a suspended individual transportation of plastic containers, particularly bottles, through a coating facility, and contains a conveying means with a clamping head for the bottleneck and an additional drive that rotates the conveying means and thus the bottle around a vertical axis, so that the coating operation can take place on all sides. Each clamping head comprises a plurality of gripper fingers which grip from above, on the outside, over the bottleneck and under a bead provided on the bottleneck. The gripper fingers are covered from the outside by a cover sleeve and are biased towards the bottleneck. The known apparatus and the known conveying means are designed for spray coating with a linear conveying path, and it remains open whether spray guns are used that can operate in a relatively accurate way. Nevertheless, there is the risk of malfunctions caused by deposited coating agents.

For painting car body parts in the automobile industry rotating atomizers are used that are adapted to the special physico-chemical properties of the paints and operate with an additional electrostatic charge, if necessary. Such a rotating atomizer is e.g. known from DE 36 34 443 A1.

Furthermore, it is e.g. known from DE-AS 25 17 504 or DE 26 28 228 C2 that glass bottles are coated electrostatically, with electrodes being accommodated in the glass bottles. Powders, consisting e.g. of polyester, acryl, polyurethane, epoxide, polyamide, polyvinyl chloride, polyethylene, etc. are predominantly sprayed and then molten in this process. Polyurethane can also be applied in liquid form and polymerized on the bottle under the action of heat. The application of heat, however, is rather undesired in the case of plastic containers. Introduction and withdrawal of the antennae are extremely detrimental to performance and are prone to failure.

It is the object of the present invention to provide an inexpensive method for the uniform coating of plastic containers, particularly PET bottles, with which the barrier properties of said containers can be enhanced efficiently, and to provide a constructionally simple apparatus for carrying out said method.

This object is achieved by the method of claim 1, the apparatus of claim 6 and the conveying means of claim 17.

The method of the invention and the apparatus of the invention permit a highly uniform coating with a high yield and thus a particularly economic increase in the barrier effect of PET bottles, or the like, thanks to the use of at least one rotating atomizer in combination with a liquid coating agent.

A very economical and uniform outer coating is achieved when according to advantageous developments of the invention the containers are moved along a curved path around the rotating atomizer, the containers being here rotated about their own axes at the same time.

To ensure a uniform coating for containers having a large height, it possible to use several rotating atomizers at different height positions. It is of particular advantage when according to various developments of the invention the rotating atomizer is moved back and forth along its axis of rotation or when its axis of rotation is inclined relative to the central axis of the containers. In such a case one single rotating atomizer is normally enough.

A particularly high performance and yield are achieved when the coating process is carried out under electrostatic charging. For instance, a voltage of 85 kV is applied to the coating agent flowing to the rotating atomizer while the containers are grounded. A yield of 95% or more can here be achieved. The loss of coating agent and the soiling of the apparatus are thus minimized to an extreme degree.

The method of the invention and the apparatus of the invention are suited for various flowable coating agents. A coating agent based on polyvinyl alcohol can be processed in a particularly easy way in an aqueous solution of 5%, optionally with addition of ethanol. A uniform coating of 1 to 5 micrometers can here be applied with the help of a single rotating atomizer within 2 to 3 seconds and at an output of about 20,000 bottles/h.

The barrier effect can solely be achieved through the coating agent applied with the help of the rotating atomizer. However, it is also possible to apply a different coating before, e.g. silicon oxide, under the action of plasma and then to apply the liquid coating agent with the rotating atomizer. This can achieve a synergistic increase in the barrier effect.

Other advantageous developments of the invention are contained in the subclaims.

Embodiments of the present invention shall now be explained in more detail with reference to the drawings, in which:

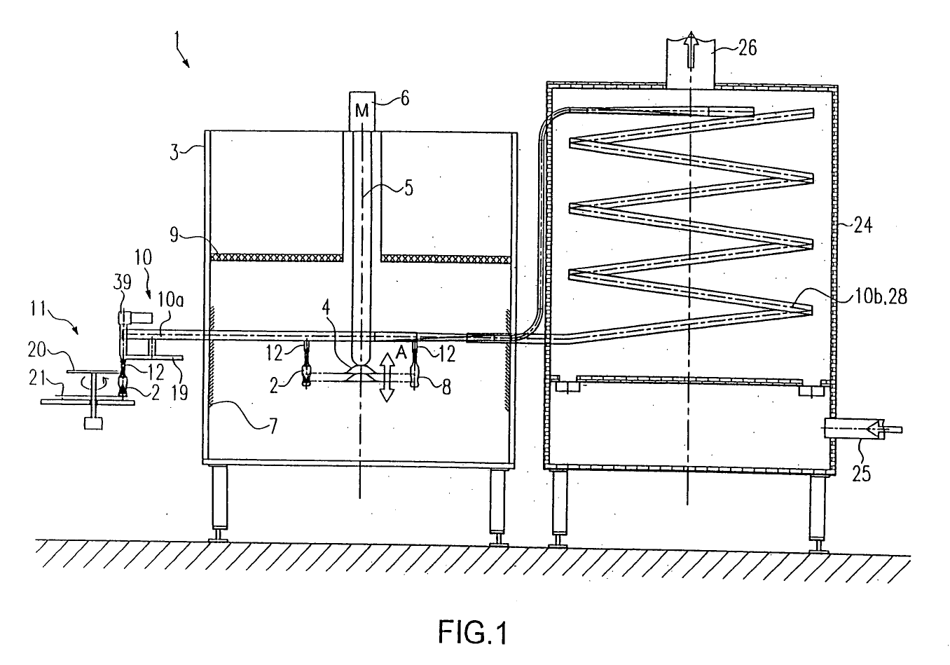

FIG. 1 is a schematic side view of an apparatus for coating PET bottles;

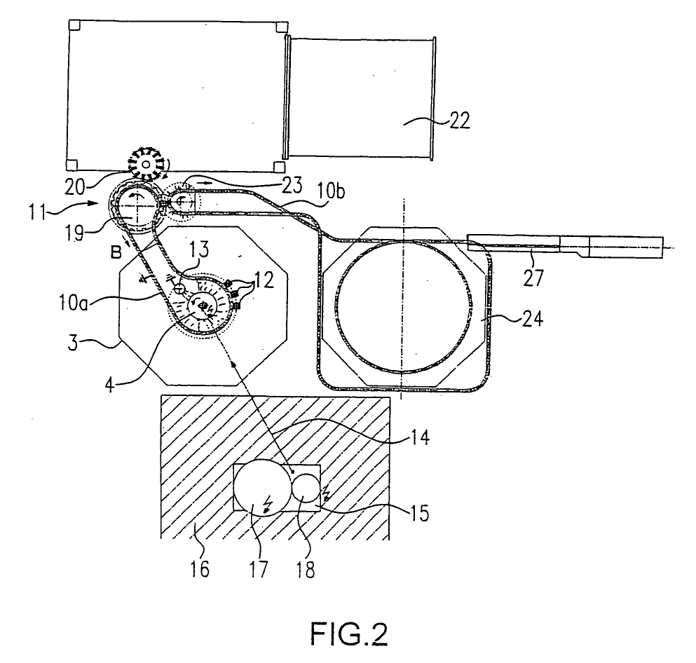

FIG. 2 is a top view on the apparatus according to FIG. 1 in a first embodiment;

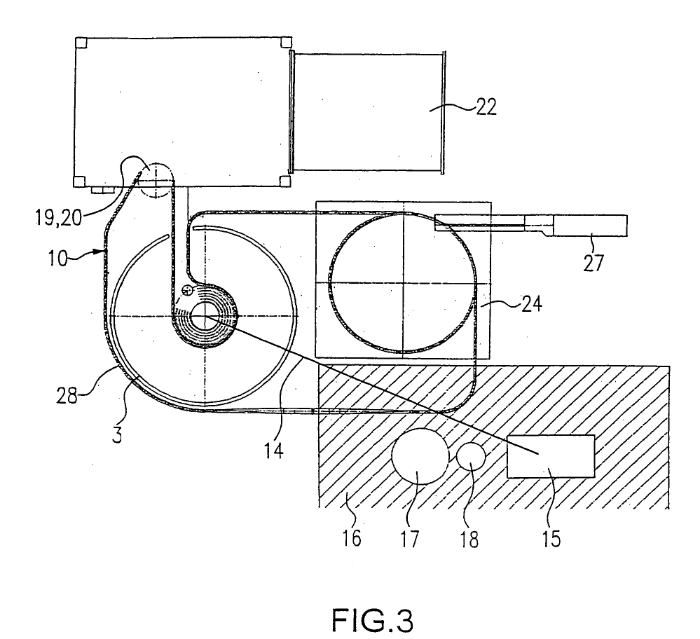

FIG. 3 is a top view on the apparatus according to FIG. 1 in a second embodiment;

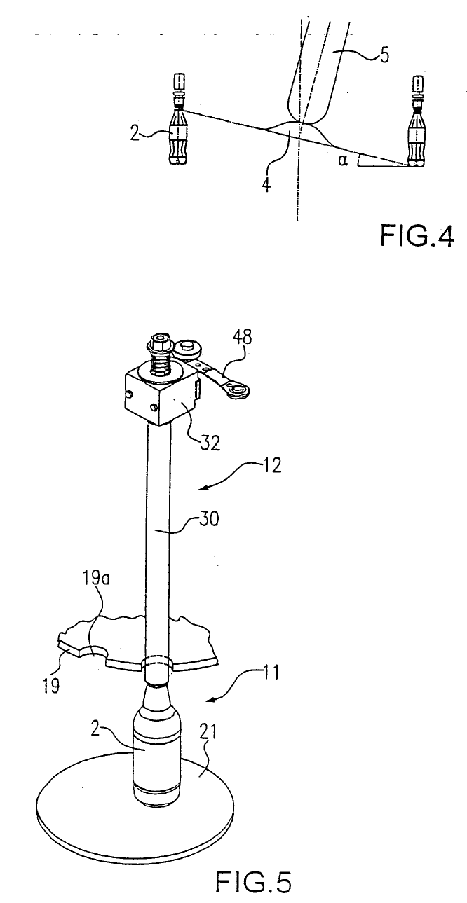

FIG. 4 is a detail view showing a modification of the apparatus according to FIG. 1;

FIG. 5 is a perspective illustration of a first conveying means;

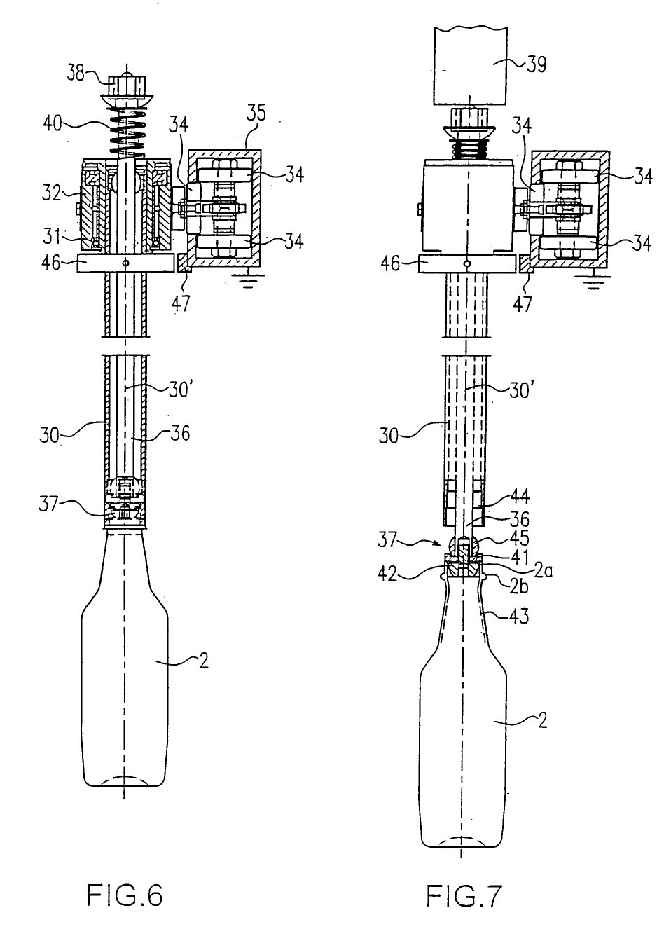

FIG. 6 shows the conveying means of FIG. 5 in a first position;

FIG. 7 shows the conveying means of FIG. 5 in a second position; and

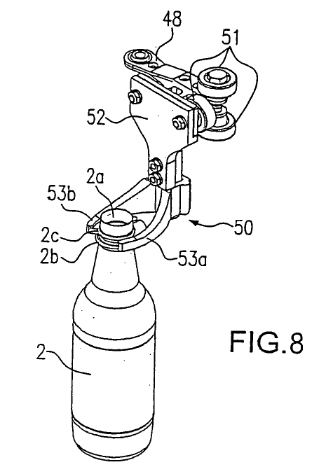

FIG. 8 is a perspective illustration of a further conveying means.

FIG. 1 shows an apparatus 1 according to the invention for coating exterior surfaces of plastic containers. Shown are bottles 2 that preferably consist of PET (polyethylene terephthalate). Such bottles are more and more used as beverage bottles. The apparatus 1 contains a coating chamber 3 which is designed as a substantially entirely closed container with walls 7. At least one rotating atomizer 4, e.g. a disc-type atomizer or a bell-type atomizer, is arranged in the interior of the coating chamber 3. The rotating atomizer 4 is rotatable via a drive shaft 5 about a vertical axis 5′ and is rotatingly driven via a motor 6. Moreover, in the illustrated embodiment, the rotating atomizer 4 can be moved upwards and downwards by the motor 6 in the direction of arrow A along the vertical axis 5′ by a displacement path that is smaller than the axial length of the container 2. The stroke frequency is about one stroke per second. A grounded electrode 8 may be accommodated within the container 2 in the usual way. The coating area inside the coating chamber 3 is delimited by an insulating cover 9.

The containers 2 are conveyed by a conveying device, which is designated by 10 on the whole. The conveying device 10 includes a suitable drive (not drawn) and, in the embodiment according to FIG. 2, a first conveyor 10a which moves the containers 2 from a transfer station 11 outside the coating chamber 3 into the coating chamber 3 and concentrically around the rotating atomizer 4 along an almost closed path formed in the manner of a circular arc. The first conveyor 10a comprises a rail 35 which is continuous over the whole path and grounded within the coating chamber 3, and conveying means 12 that are capable of conveying each container 2 individually and in suspended fashion. The conveying means 12 closely follow one another and are coupled with one another, but only portions of the conveying means are outlined in FIGS. 1 and 2 for the sake of clarity of the drawings.

The path formed by the grounded rail 35 of the conveying means 10a around the rotating atomizer 4 is closed by a cylinder 13, which is under a positive high voltage, in the withdrawal and introduction area in which the path is slightly open by necessity, the cylinder 13 repelling the particles of the coating agent with the same charge.

The rotating atomizer 4 is supplied via a supply line 14 with a coating agent based on 5% PVAL (polyvinyl alcohol) in an aqueous solution. The supply line 14 leads from a mixing chamber 15 in a mixing means 16 through the drive shaft 5 into the rotating atomizer 4. In the mixing means 16 there is a reservoir 17 for water and a reservoir 18 for PVAL and devices (not drawn) used for electrostatic charging, which are also connected to the shaft 5 and to the lines contained therein for the coating agent and/or the rotating atomizer 4, so that the droplets of the coating agent leaving the rotating atomizer 4 have a positive potential of about 85 kV.

The transfer station 11 contains a support star 19 for aligning the conveying means 12, and a transfer star 20 with a support disc 21 for the bottom of the container 2.

The transfer station 11 takes over the containers 2 in the conventional known manner from a precoating facility 22 in which the containers 2 have been provided with a first coat, a coating for achieving different characteristics and/or a further coating for improving the barrier properties, for instance a plasma coating based on SiO₂.

The method of the invention is carried out in that at the transfer station 11 one container each is taken over by a corresponding conveying means 12 and conveyed in suspended fashion and individually in an uninterrupted series along the path of the conveyor 10a in the direction of arrow B, the conveying means 12 being rotated in a way described further below—at least along their path around the rotating atomizer 54—additionally about their own axis, namely approximately three times during the coating process.

The rotating atomizer 4 is fed via line 14 with the aqueous solution of the electrostatically charged coating agent and is sprayed in finely divided form by rotation of the rotating atomizer. The whole axial length of the container 2 is swept over in this process by the axial movement over stroke A upwards and downwards. A continuous stream of the particles of the coating agent is generated through the electrostatic charging by the rotating atomizer 4 towards the containers 2 grounded by contact with the conveyor 10, which further improves the coating result.

The stroke movement A can expediently be controlled at a variable speed, the rotating atomizer 4 dwelling in those exterior areas of the container 2 that have a larger surface, e.g. the body of a bottle, for a longer time than in those areas of the container that have a smaller exterior surface, e.g. on the bottleneck. A uniform layer thickness can thereby be achieved with an adjustable thickness ranging from 2 to 3 μm during a coating duration of 2 to 3 sec.

However, as is also shown in FIG. 4, the rotating atomizer 4 can be tilted by the angle alpha or made to tumble, so that the radial jet, for instance of a disc-type rotating atomizer, sweeps over the whole axial length of the container 2, the movement taking place at a faster pace at the deflection points in the area of the bottleneck and the drawn-in bottle bottom, so that approximately the same layer thickness is there achieved as on the belly of the bottle.

After the coating process the containers 2 that are suspended from the conveying means 12 will leave the coating chamber 3 and arrive at a second transfer point 23 in which the containers 3 are transferred to a second conveyor 10b of the conveying device 10. On this conveyor 10b, the containers 2 are passed into a drying chamber 24 and there guided in spiral form from the bottom to the top. The drying chamber 24 is also constructed as a closed container and has a hot-air supply means 25 and an exhaust air discharge means 26. The exterior coating is dried within a few minutes during transportation through the drying chamber 24. The finish-coated and dried containers are discharged via a discharge conveyor 27 for further treatment.

As shown in FIG. 3, instead of the separated conveyors 10a for the coating chamber 3 and 10b for the drying chamber 24, the conveying device 10 may be provided with a single conveyor 28 that transports the containers 2 first of all through the coating chamber 3 and then, without any transfer, through the drying chamber 24. The other features of FIG. 3 are identical with the above-described features of FIGS. 1 and 2 and are marked with the same reference numerals and will not be explained once again.

The conveying means 12 will be explained in more detail in the following with reference to FIGS. 5 to 7. The conveying means 12 contains a protective tube 30 which is connected via a rotary bearing 31 to a carriage 32 that is running via rollers 34 in a suitable rail 35. The protective tube 30 is supported on the carriage 32 in an axially immovable manner and with a vertical central line 30′. An actuating rod 36 which is connected to a frictionally operating clamping head 37 at the free end of the protective tube 30 that is facing away from the carriage 32 extends through the interior of the protective tube 30. The other free end of the actuating rod 36 projects out of the upper free end of the protective tube 30 and is there provided with a press member 38 that can get into engagement with a stationary cam 39 which is arranged at suitable places in the conveying device 10. The press member 38 is supported via a spring 40 on the carriage 42. The cam 39 presses the press member 38 against the action of spring 40 to such an extent onto the carriage 32 that the actuating rod 36 exits with the clamping head 37 out of the lower free end of the protective tube 30.

The clamping head 37 has a stop 41 and an elastic friction ring 42 in the form of a spring ring. The stop 41 is designed such that it can be placed on an upper edge surrounding an opening 2a of the container 2. The friction ring 42 is positioned on a attachment 43 which engages into the opening 2a, the friction ring 42 resting in frictional fashion on the inner surface in the area of the opening 2a in such a manner that the container 2 is entrained upon movement of the actuating rod 36 as soon as the attachment 43 has been slid up to stop 41 into the opening 2a of the container 2.

On its upper side the stop 41 further abuts on a counter-stop 44 in the interior of the protective tube 30 as soon as the spring 40 has been enabled to push the press member 38 and thus the actuating rod 36 upwards into the position drawn in FIG. 6. The counter-stop 44 is arranged such that the whole clamping head 37 and the threaded portion of the container 2 that is seated on attachment 43 passes into the protective tube 30 and is thus protected by the protective tube 30 from coating. The container 2 is further provided with an edge bead or neck collar 2b that is arranged at a distance below the opening 2a and abuts, if necessary, on the free end of the protective tube 30 as soon as the clamping head 37 has disappeared in the protective tube 30. The clamping head 37 is here guided by a spherical guide element 45.

Thanks to the metallic contact via spring ring 42 and clamping head 37 in the interior and the protective tube 30 on the outside, the container 2 is well grounded, so that a uniform outer coating is possible without a cathode being arranged in the interior.

The protective tube 30 is connected for rotation with a friction wheel 46 of a further drive that is in engagement with a stationary friction rail 47. The friction rail 47 is arranged at those places where the container 2 must be rotated about axis 30′, i.e. especially along the path around the rotating atomizer 4. Sometimes, however, it may be expedient to rotate the containers 2 in areas of the drying chamber 34. The friction wheel 46 transmits the rotary movement onto the protective tube 30, and the protective tube 30 transmits the rotary movement onto the clamping head 37 and thus onto the container 2 as long as the friction head 37 is in the protective tube 30, which ensures a reliable stabilization of the container during rotation.

As is especially shown in FIG. 5, the protective tube 30 may be relatively long without its function being impaired. It is thereby possible to arrange the containers 2 at a safe distance from the carriage 32, so that a soiling of carriage 32 and rail 35 is largely avoided. Preferably, the protective tube 30 is longer than the axial length of the container 2.

As shown in FIG. 5, the containers 2 are automatically received by the conveying means 12 when the conveying means 12 and the containers 2 are united in the area of the transfer station 11. The conveying means 12 are conveyed by the conveying device 10 at predetermined distances into the area of the support star 19, the predetermined distances between the conveying means 12 being defined by connecting lugs 48 that hingedly connect two successive carriages 32 to one another. The support star 19 accommodates a respective protective tube 30 of a conveying means 12 in a recess 19a, so that an oscillating movement of the long protective tube 30 is avoided. On the support disk 21, laterally guided by the transfer wheel 20 (not drawn), which is also provided with recesses that are operative in the area of the bottleneck and the bottle body, the containers 2 are supplied. As soon as the protective tube 30 is positioned above the bottleneck, a suitably mounted cam 39 will ensure that the clamping head 37 is moved out of the protective tube 30 and into the opening 2a of the container 2 with its attachment 43 until the stop 41 abuts on the upper edge, the friction ring 42 being elastically compressed, thereby producing the clamping force needed. The container 2 is thus firmly seated on the clamping head 37 and can be moved together with the clamping head 37 relative to the protective tube 30. During its movement through the coating chamber 3 the clamping head 37 is pulled by relaxation of the spring 40 into the protective tube 30, the protective tube 30 protecting the clamping head 37 and the head portion of the container 2 near the edge, where a thread is seated most of the time, against undesired coating.

When the container 2 is to be removed from the clamping head 37 again, the clamping head is pushed to the outside again via a cam 39, so that the container 2 is gripped by suitable devices and can be drawn off.

This withdrawal can be carried out by a conveying means 50, which is shown in more detail in FIG. 8, the conveying means being used as a conveying means on the second conveyor 10b through the drying chamber 24. The conveying means 50 is again designed for a suspended individual transportation of the containers 2, particularly of bottles. An expedient arrangement of rollers 51 ensures that the conveying means 50 can run on the same rails 35 as the conveying means 12. The conveying means 50 also contains a carriage 52 to which a pair of elastic gripper arms 53a and 53b are secured that form a gripper clamp whose opening width in the relaxed state is slightly smaller than the outer diameter of the container 2 directly above the bead 2b.

The container 2 is e.g. transferred at the transfer station 23 of FIG. 2 by the conveying means 12 to the conveying means 50 by the measure that a cam 39 first of all makes sure that the clamping head 37 of the conveying means 12 is moved with the suspended container 2 out of the protective tube 30. The conveying means 12 is then guided into the area of the conveying means 50, so that the elastic gripper arms 53a and 53b slide around the bottleneck above the bead 2b. When the clamping head 37 is now moved by the spring 40 upwards, the bead 2b will abut on the gripper arms 53a and 53b from below, so that the container 2 is wiped off from the clamping head 37 and positively held by the clamping force of the elastic gripper arms 53a and 53b and entrained upon movement of the conveying means 50.

The holding force of the gripper arms 53a, 53b can also be supported by a further bead 2c which is positioned above the bead 2b at a distance corresponding to the width of the gripper arms 53a, 53b.

In a modification of the described and depicted embodiments, the method and the apparatus can also be used for coating containers of a different type and with different coating agents. The conveying means can convey the containers also into other areas of a handling facility for such containers, outside of coating and drying facilities. Instead of the clamping head, the protective tube may also be moved axially. The coating agent can be mixed directly in the line leading to the rotating atomizer and shortly before its exit and/or can be charged statically. Instead of a single rotating atomizer, it is possible to use several rotating atomizers, the rotating atomizers being supplied with different amounts of coating per time unit, so that either different layer thicknesses can be achieved or a uniform layer thickness on surfaces of different sizes. The drying operation can also be carried out by way of UV radiation or by other suitable drying means.

1. A method for coating a plastic container provided with an opening, particularly a PET bottle, characterized in that the container (2) is provided on its outside with a liquid coating agent by a rotating atomizer (4) for improving the barrier properties thereof and the coating is subsequently dried.

2. The method according to claim 1, characterized in that the container (2) is moved along a curved path around the rotating atomizer (4).

3. The method according to claim 1 or 2, characterized in that the container (2) is rotated about its own axis during coating.

4. The method according to any one of claims 1 to 3, characterized in that the coating operation is carried out under electrostatic charging.

5. The method according to claim 4, characterized in that the coating agent is electrostatically charged, and the container (2) is grounded.

6. An apparatus for coating a plastic container provided with an opening, particularly a PET bottle, especially for carrying out the method according to any one of claims 1 to 5, characterized by a coating chamber (3) provided with at least one rotating atomizer (4), a drying chamber (24) following the coating chamber (3), and a conveying device (10) for conveying the container (2) along a curved path around the rotating atomizer (4).

7. The apparatus according to claim 6, characterized in that the rotating atomizer (4) is axially displaceable along its axis of rotation.

8. The apparatus according to claim 6 or 7, characterized in that the axis of rotation of the rotating atomizer (4) is inclined relative to the central axis of the container (2).

9. The apparatus according to any one of claims 6 to 8, characterized in that the mixing chamber (15) for the coating agent and/or the supply line (14) of the coating agent to the rotating atomizer (4) and/or the rotating atomizer (4) is/are connected to a high-voltage generator.

10. The apparatus according to any one of claims 6 to 9, characterized in that the conveying device (10) comprises a joint conveyor (28) guided through both the coating chamber (3) and the drying chamber (24).

11. The apparatus according to any one of claims 6 to 9, characterized in that the conveying device (10) comprises a first conveyor (10a) in the coating chamber (3), a second conveyor (10b) in the drying chamber (24), and a transfer station (23) arranged between the two conveyors (10a, 10b).

12. The apparatus according to any one of claims 6 to 11, characterized in that the conveying device (10) comprises a conveying means (12) for the suspended individual transportation of the container (2), the conveying means (12) comprising a clamping head (37) engaging into the opening (2a) of the container, and a protective tube (30), the clamping head (37) being movable relative to the protective tube (30) in such a way that it its arranged in a first position inside the protective tube (30) and projects in a second position out of the protective tube (30).

13. The apparatus according to claim 12, characterized in that the protective tube (30) has an axial length exceeding the axial length of the container (2).

14. The apparatus according to claim 12 or 13, characterized in that the clamping head (37) is movable by an actuating rod (36) relative to the protective tube (30), the actuating rod (36) extending axially through the protective tube (30), loaded by a spring (40) in the first position of the friction head (37) and provided with a cam engagement surface (38) by which the clamping head (37) can be pressed against the action of the spring (40) into its second position.

15. The apparatus according to any one of claims 12 to 14, characterized in that the conveying means (12) comprises a friction drive (46, 47) for rotating the clamping head (37) about its axis (30′).

16. The apparatus according to any one of claims 12 to 15, characterized in that the conveying device (10) comprises a conveying means (50) for the suspended individual transportation of the container (2), the conveying means including an elastic gripper clamp (53a, 53b) cooperating with a bead (2b) around the opening (2a) of the container (2).

17. A conveying means for conveying a plastic container provided with an opening, particularly a PET bottle, comprising a clamping tool engaging into the opening and a protective jacket covering the area around the opening, particularly for an apparatus according to any one of claims 12 to 16, characterized in that the clamping tool is designed as a clamping head (37) and the protective jacket as a protective tube (30), the clamping head (37) being movable relative to the protective tube (30) such that it is recessed in a first position in the protective tube (30) and projects in a second position out of an end of the protective tube (30).

18. The conveying means according to claim 17, characterized in that the clamping head (37) is movable by an actuating rod (36) relative to the stationary protective tube (30), the actuating rod (36) extending axially through the protective tube (30), loaded by a spring (40) in the first position of the clamping head (37) and provided with a cam engagement surface (38) by which the clamping head (37) can be pressed against the action of the spring (40) into its second position.
